(19) United States
(12) Patent Application Publication
(10) Pub. No.: US 2023/0391906 A1
(43) Pub. Date: Dec. 7, 2023

(54) CYCLIC OLEFIN COPOLYMER PRODUCTION METHOD

(71) Applicant: Polyplastics Co., Ltd., Tokyo (JP)

(72) Inventors: Tomoyuki Tada, Fuji-shi (JP); Naoyuki Wakitani, Fuji-shi (JP); Hiroyuki Komatsu, Fuji-shi (JP)

(21) Appl. No.: 18/247,420

(22) PCT Filed: Sep. 16, 2021
(86) PCT No.: PCT/JP2021/034140

§ 371 Date: Mar. 30, 2023

(30) Foreign Application Priority Data
Oct. 2, 2020 (JP) 2020-167981

(51) Int. Cl. C08F 210/02; C08F 4/6592

(52) U.S. Cl. CPC C08F 210/02; C08F 4/6592

(57) ABSTRACT

A production method for a cyclic olefin copolymer which is capable of efficiently producing a cyclic olefin copolymer by copolymerizing monomers including a norbornene monomer and ethylene while suppressing the formation of a polyethylene-like impurity. The monomers including a norbornene monomer and ethylene are polymerized in the presence of a metallocene catalyst containing a cyclopentadiene ligand which is substituted with an alkyl group optionally substituted with a halogen atom, or a trialkylsilyl group, and satisfies specific conditions for substituent(s).

### TECHNICAL FIELD

The present invention relates to a method for producing a cyclic olefin copolymer including a structural unit derived from a norbornene monomer and a structural unit derived from ethylene.

### BACKGROUND ART

Cyclic olefin homopolymers and copolymers have low hygroscopicity and high transparency, and find use in various applications including the field of optical materials such as optical disc substrates, optical films, optical fibers.

Copolymers of a cyclic olefin and ethylene, which are in widespread use as transparent resins, typify such cyclic olefin copolymers. The copolymers of a cyclic olefin and ethylene can have variable glass transition temperatures (Tg) depending on the copolymerization composition thereof, and therefore copolymers having the glass transition temperature thereof tuned in a wide temperature range can be produced (see, for example, Nonpatent Document 1).
Non-Patent Document 1: Incoronata, Tritto et al., Coordination Chemistry Reviews, 2006, vol. 250, pp. 212-241

### DISCLOSURE OF THE INVENTION

### Problems to be Solved by the Invention

Unfortunately, the methods described in Nonpatent Document 1 have difficulty producing the copolymers of a cyclic olefin and ethylene in high yields. A possible solution for this difficulty is to conduct the polymerization using a highly active catalyst. However, when the polymerization is conducted using a highly active catalyst for the purpose of increasing the production efficiency of the cyclic olefin copolymers, a polyethylene-like impurity may be more readily co-produced.

When a cyclic olefin copolymer contains a polyethylene-like impurity, such a cyclic olefin copolymer is highly likely to give a turbid solution upon the dissolution thereof in a solvent. As can also be understood from such a phenomenon, the inclusion of the polyethylene-like impurity in the cyclic olefin copolymer would impair the transparency of the cyclic olefin copolymer. Furthermore, the formation of the polyethylene-like impurity would require a process for filtering and removing the insoluble polyethylene-like impurity in a common production process for the production of the cyclic olefin copolymer, which would increase production costs.

The present invention takes the above circumstances into consideration, with an object of providing a production method for a cyclic olefin copolymer, which is capable of efficiently producing a cyclic olefin copolymer by copolymerizing monomers including a norbornene monomer and ethylene while suppressing the formation of a polyethylene-like impurity.

### Means for Solving the Problems

The present inventors found that the above-mentioned problems can be solved by polymerizing monomers including a norbornene monomer and ethylene in the presence of a metallocene catalyst containing a cyclopentadiene ligand which is substituted with an alkyl group optionally substituted with a halogen atom, or a trialkylsilyl group, and satisfies specific conditions for substituent(s), to accomplish the present invention. More specifically, the present invention provides the following.

A first aspect of the present invention relates to a method for producing a cyclic olefin copolymer including a structural unit derived from a norbornene monomer and a structural unit derived from ethylene, the method including: charging at least the norbornene monomer and the ethylene as monomers into a polymerization vessel; and polymerizing the monomers in the polymerization vessel in the presence of a metallocene catalyst, wherein the metallocene catalyst is a compound represented by the following formula (a1):

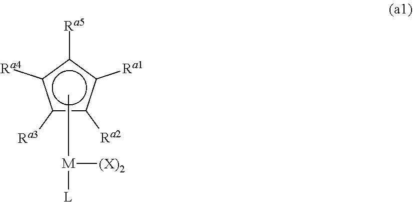

wherein in the formula (a1), M represents Ti, Zr, or Hf, R^{a1} to R^{a5} may be identical to or different from one another, and each independently represent a hydrogen atom, an alkyl group optionally substituted with a halogen atom, or a trialkylsilyl group,
wherein at least one of R^{a1} to R^{a5} represents the alkyl group optionally substituted with a halogen atom, or the trialkylsilyl group,
when only one of R^{a1} to R^{a5} represents the alkyl group optionally substituted with a halogen atom, or the trialkylsilyl group, the sum of the number of carbon atoms and the number of silicon atoms in the alkyl group optionally substituted with a halogen atom, or the trialkylsilyl group is 1 or more and 10 or less,
when two or more of R^{a1} to R^{a5} represent the alkyl group optionally substituted with a halogen atom, or the trialkylsilyl group, the sum of the number of carbon atoms and the number of silicon atoms for all of R^{a1} to R^{a5} is 2 or more and 5 or less, and when R^{a1} to R^{a5} include the alkyl group having 2 to 4 carbon atoms and optionally substituted with a halogen atom, or the trimethylsilyl group, only one of R^{a1} to R^{a5} represents the alkyl group having 2 to 4 carbon atoms and optionally substituted with a halogen atom, or the trimethylsilyl group, and
two adjacent groups from among R⁴¹ to R¹⁵ on the 5-membered ring are optionally bonded to each other to form a hydrocarbon ring, X represents an organic substituent having 1 to 20 carbon atoms and optionally containing a heteroatom, or a halogen atom, and
L represents a group represented by the following formula (ala):

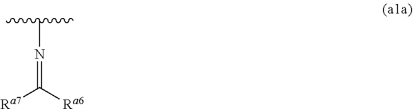

wherein in the formula (ala), R^{a6} and R^{a7} may be identical to or different from each other, and each independently represent a hydrogen atom, an organic substituent having 1 to 20 carbon atoms and optionally containing a heteroatom, or an inorganic substituent, and two groups R^{a6} and R^{a7} are optionally bonded to each other to form a ring.

A second aspect of the present invention relates to the method for producing a cyclic olefin copolymer according to the first aspect, wherein four of R^{a1} to R^{a5} represent a hydrogen atom or a methyl group, and one of R^{a1} to R^{a5} represents a trialkylsilyl group.

A third aspect of the present invention relates to the method for producing a cyclic olefin copolymer according to the first or second aspect, wherein M represents Ti.

A fourth aspect of the present invention relates to the method for producing a cyclic olefin copolymer according to any one of the first to third aspects, wherein the polymerizing of the monomers is performed in the presence of the metallocene catalyst, and at least one selected from an aluminoxane or a borate compound.

A fifth aspect of the present invention relates to the method for producing a cyclic olefin copolymer according to any one of the first to fourth aspects, wherein polymerizing of the monomers is performed in the presence of an aliphatic hydrocarbon solvent.

A sixth aspect of the present invention relates to the method for producing a cyclic olefin copolymer according to any one of the first to fifth aspects, wherein a DSC curve obtained in the measurement of a sample of the cyclic olefin copolymer according to the method defined in JIS K7121 using a differential scanning calorimeter in a nitrogen atmosphere under the condition of a rate of temperature increase of 20° C./min shows no peak of a melting point assigned to a polyethylene-like impurity in the range of 100° C. to 140° C.

### Effects of the Invention

The present invention can provide a production method for a cyclic olefin copolymer, which is capable of efficiently producing a cyclic olefin copolymer by copolymerizing monomers including a norbornene monomer and ethylene while suppressing the formation of a polyethylene-like impurity.

### PREFERRED MODE FOR CARRYING OUT THE INVENTION

### <<Production Method for Cyclic Olefin Copolymer>>

In the production method for a cyclic olefin copolymer, a cyclic olefin copolymer including a structural unit derived from a norbornene monomer and a structural unit derived from ethylene is produced. The production method includes: charging at least a norbornene monomer and ethylene as monomers into a polymerization vessel, and
polymerizing the monomers in the polymerization vessel in the presence of a metallocene catalyst. Hereinafter, the charging of the norbornene monomer and ethylene as the monomer into the polymerization vessel is also referred to as a charging step. Further, the polymerizing of the monomers in the polymerization vessel in the presence of the metallocene catalyst is also referred to as a polymerization step.

The monomers in the polymerization vessel are polymerized in the presence of a metallocene catalyst. The metallocene catalyst will be described later in detail.

In the copolymerization of ethylene and a norbornene monomer in the presence of a highly active catalyst, ethylene homopolymerization is generally likely to proceed, more readily leading to the formation of a polyethylene-like impurity.

However, the polymerization of ethylene and the norbornene monomer using the metallocene catalyst as described later is likely to produce the cyclic olefin copolymer in a favorable yield, while suppressing the formation of the polyethylene-like impurity.

### <Charging Step>

In the charging step, the norbornene monomer and ethylene are charged as the monomers into a polymerization vessel. Any monomer other than the norbornene monomer and ethylene may be charged into the polymerization vessel, so long as the effects of the present invention is not impaired. The sum of the ratio of the structural units derived from the norbornene monomer and the ratio of the structural units derived from ethylene in the cyclic olefin copolymer is typically preferably 80% by mass or more, more preferably 95% by mass or more, and even more preferably 98′% by mass or more based on the total structural units.

The monomer other than the norbornene monomer and ethylene is not particularly limited so long as it is copolymerizable with the norbornene monomer and ethylene. Typical examples of such other monomer include α-olefins. Such an α-olefin may be substituted with at least one substituent such as a halogen atom.

The α-olefin is preferably a C3 to C12 α-olefin. The C3 to C12 α-olefin is not particularly limited, and examples thereof include propylene, 1-butene, 1-pentene, 1-hexene, 3-methyl-1-butene, 3-methyl-1-pentene, 3-ethyl-1-pentene, 4-methyl-1-pentene, 4-methyl-1-hexene, 4,4-dimethyl-1-hexene, 4,4-dimethyl-1-pentene, 4-ethyl-1-hexene, 3-ethyl-1-hexene, 1-octene, 1-decene, 1-dodecene, etc. Among these, 1-hexene, 1-octene and 1-decene are preferable.

The way of charging ethylene into the polymerization solution is not particularly limited, so long as the desired amount of ethylene can be charged into the polymerization vessel. Ethylene is typically charged into the polymerization vessel so as to achieve a charge pressure of ethylene in the polymerization vessel of 0.5 MPa or more. The charge pressure of ethylene is preferably 0.55 MPa or more, and more preferably 0.6 MPa or more. When the charge pressure of ethylene is high, the amount of the catalyst used per product polymer can be reduced. The upper limit of the charge pressure of ethylene is, for example, preferably 10 MPa or less, more preferably 5 MPa or less, and even more preferably 3 MPa or less.

A solvent may be charged into the polymerization vessel together with the norbornene monomer and ethylene. The solvent is not particularly limited, so long as the solvent does not inhibit the polymerization reaction. Examples of a preferable solvent include hydrocarbon solvents such as aliphatic hydrocarbon solvents and aromatic hydrocarbon solvents, and halogenated hydrocarbon solvents, and hydrocarbon solvents are preferable, and aliphatic hydrocarbon solvents are more preferable in light of their excellent handling characteristics, thermal stability and chemical stability. Specific examples of the preferable solvent include aliphatic hydrocarbon solvents such as pentane, hexane, heptane, octane, isooctane, isododecane, mineral oil, cyclohexane, methylcyclohexane, and decahydronaphthalene (decalin); aromatic hydrocarbon solvents such as benzene, toluene, and xylene; and halogenated hydrocarbon solvents such as chloroform, methylene chloride, dichloromethane, dichloroethane, and chlorobenzene.

In the case where the norbornene monomer is charged into the solvent, the lower limit of the concentration of the norbornene monomer is, for example, preferably 0.5% by mass or more, and more preferably 10% by mass or more. The upper limit of the concentration of the norbornene monomer is, for example, preferably 50% by mass or less, and even more preferably 35% by mass or less.

In the following, the norbornene monomer will be described.

### [Norbornene Monomer]

Examples of the norbornene monomer include norbornene and a substituted norbornene, and norbornene is preferable. One type of the norbornene monomer may be used alone, and two or more types of norbornene monomers may be used in combination.

The substituted norbornene is not particularly limited, and examples of a substituent included in the substituted norbornene include a halogen atom and a monovalent or divalent hydrocarbon group. Specific examples of the substituted norbornene include a compound represented by the following general formula (I).

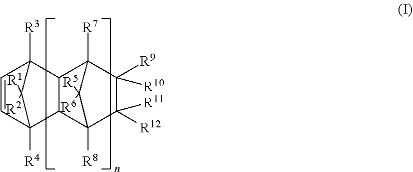

In the formula, R¹ to R¹² may be identical to or different from one another, and are each independently selected from the group consisting of a hydrogen atom, a halogen atom and a hydrocarbon group, R⁹ and R¹⁰, and R¹¹ and R¹² optionally combine to form a divalent hydrocarbon group, R⁹ or R¹⁰ and R¹¹ or R¹² optionally form a ring with each other.

Further, n represents 0 or a positive integer, and when n is two or more, R⁵ to R⁸ may be identical to or different from each other in the respective repeating units.

In addition, when n is 0, at least one of R¹ to R⁴ and R⁹ to R¹² is not a hydrogen atom.

The substituted norbornene represented by the general formula (I) will be described. R¹ to R¹² in the general formula (I) may be identical to or different from one another, and are each independently selected from the group consisting of a hydrogen atom, a halogen atom and a hydrocarbon group.

Specific examples of R¹ to R⁶ include a hydrogen atom; a halogen atom such as fluorine, chlorine and bromine; an alkyl group having 1 to 20 carbon atoms, and the like, and R¹ to R⁸ may be different from each other, a part of R¹ to R⁸ may be different from one another, and all of R¹ to R⁸ may be identical to one another.

Further, specific examples of R⁹ to R¹² include a hydrogen atom; a halogen atom such as fluorine, chlorine and bromine; an alkyl group having 1 to 20 carbon atoms; a cycloalkyl group such as a cyclohexyl group; a substituted or unsubstituted aromatic hydrocarbon group such as a phenyl group, a tolyl group, an ethylphenyl group, an isopropylphenyl group, a naphthyl group and an anthryl group; an aralkyl group such as a benzyl group, a phenethyl group, and other aryl-group-substituted alkyl group, and the like, and R⁹ to R¹² may be different from each other, a part of R⁹ to R¹² may be different from one another, and all of R⁹ to R¹² may be identical to one another.

Specific examples of the divalent hydrocarbon group when R⁹ and R¹⁰, or R¹¹ and R¹² taken together form a divalent hydrocarbon group include an alkylidene group such as an ethylidene group, a propylidene group and an isopropylidene group, and the like.

When R⁹ or R¹⁰ and R¹¹ or R¹² form a ring with each other, the ring formed thereby may be a monocyclic or polycyclic ring, a bridged polycyclic ring, or a ring having a double bond, or may be a ring having a combination of these rings. In addition, these rings may have a substituent such as a methyl group.

Specific examples of the substituted norbornene represented by the general formula (I) include: bicyclic olefins such as 5-methyl-bicyclo[2.2.1]hept-2-ene, 5,5-dimethyl-bicyclo[2.2.1]hept-2-ene, 5-ethyl-bicyclo[2.2.1]hept-2-ene, 5-butyl-bicyclo[2.2.1]hept-2-ene, 5-ethylidene-bicyclo[2.2.1]hept-2-ene, 5-hexyl-bicyclo[2.2.1]hept-2-ene, 5-octyl-bicyclo[2.2.1]hept-2-ene, 5-octadecyl-bicyclo[2.2.1]hept-2-ene, 5-methylidene-bicyclo[2.2.1]hept-2-ene, 5-vinyl-bicyclo[2.2.1]hept-2-ene, 5-propenyl-bicyclo[2.2.1]hept-2-ene;
tricyclic olefins such as tricyclo[4.3.0.1^{2,5}]deca-3,7-diene (trivial name: dicyclopentadiene), tricyclo[4.3.0.1^{2,5}]deca-3-ene; tricyclo[4.4.0.1^{2,5}]undeca-3,7-diene or tricyclo[4.4.0.1^{2,5}]undeca-3,8-diene or a partially hydrogenated product thereof (or an adduct of cyclopentadiene and cyclohexene), i.e., tricyclo[4.4.0.1^{2,5}]undeca-3-ene; 5-cyclopentyl-bicyclo[2.2.1]hept-2-ene, 5-cyclohexyl-bicyclo[2.2.1]hept-2-ene, 5-cyclohexenylbicyclo[2.2.1]hept-2-ene and 5-phenyl-bicyclo[2.2.1]hept-2-ene;
tetracyclic olefins such as tetracyclo[4.4.0.1^{2,5}.1^{7,10}]dodeca-3-ene (which may be referred to simply as tetracyclododecene), 8-methyltetracyclo[4.4.0.1^{2,5}.1^{7,10}]dodeca-3-ene, 8-ethyltetracyclo[4.4.0.1^{2,5}.1^{7,10}]dodeca-3-ene, 8-methylidenetetracyclo[4.4.0.1^{2,5}.1^{7,10}]dodeca-3-ene, 8-ethylidenetetracyclo[4.4.0.1^{2,5}.1^{7,10}]dodeca-3-ene, 8-vinyltetracyclo[4.4.0.1^{2,5}.1^{7,10}]dodeca-3-ene and 8-propenyl-tetracyclo[4.4.0.1^{2,5}.1^{7,10}]dodeca-3-ene; and
polycyclic olefins such as 8-cyclopentyl-tetracyclo[4.4.0.1^{2,5}.1^{7,10}]dodeca-3-ene, 8-cyclohexyl-tetracyclo[4.4.0.1^{2,5}.1^{7,10}]dodeca-3-ene, 8-cyclohexenyl-tetracyclo[4.4.0.1^{2,5}.1^{7,10}]dodeca-3-ene, 8-phenyl-cyclopentyl-tetracyclo[4.4.0.1^{2,5}.1^{7,10}]dodeca-3-ene;
tetracyclo[7.4.1^{3,6}.0^{1,9}.0^{2,7}]tetradeca-4,9,11,13-tetraene (which may also be referred to as 1,4-methano-1,4,4a,9a-tetrahydrofluorene), tetracyclo[8.4.1^{4,7}.0^{1,10}.0^{3,8}]pentadeca-5,10,12,14-tetraene (which may also be referred to as 1,4-methano-1,4,4a,5,10,10a-hexahydroanthracene);
pentacyclo[6.6.1.1^{3,6}.0^{2,7}.0^{9,14}]-4-hexadecene, pentacyclo[6.5.1.1^{3,6}.0^{2,7}.0^{9,13}]-4-pentadecene, pentacyclo[7.4.0.0^{2,7}.1^{3,6}.1^{10,13}]-4-pentadecene;
heptacyclo[8.7.0.1^{2,9}.1^{4,7}.1^{11,17}.0^{3,8}.0^{12,16}]-5-eicosene, heptacyclo[8.7.0.1^{2,9}.0^{3,8}.1^{4,7}.0^{12,17}.1^{13,16}]-14-eicosene; and a tetramer of cyclopentadiene.

Among these, alkyl-substituted norbornenes (e.g., bicyclo[2.2.1]hept-2-ene substituted with one or more alkyl group(s)), alkylidene-substituted norbornenes (e.g., bicyclo[2.2.1]hept-2-ene substituted with one or more alkylidene group(s)) are preferable, and 5-ethylidene-bicyclo[2.2.1]hept-2-ene (trivial name: 5-ethylidene-2-norbornene, or simply ethylidenenorbornene) is particularly preferable.

### <Polymerization Step>

In the polymerization step, the monomers in the polymerization vessel are polymerized in the presence of the metallocene catalyst which satisfy the predetermined requirements. The temperature during polymerization is not particularly limited. The temperature during polymerization is preferably 20° C. or higher, more preferably 30° C. or higher, even more preferably 50° C. or higher, still more preferably 60° C. or higher, and particularly preferably 70° C. or higher because of a favorable yield of the cyclic olefin copolymer, etc. The temperature during polymerization may be 80° C. or higher. The upper limit of the temperature during polymerization is not particularly limited, and may be, for example, 200° C. or lower, 140° C. or lower, or 120° C. or lower.

A metallocene compound represented by the following formula (a1) is used as the metallocene catalyst.

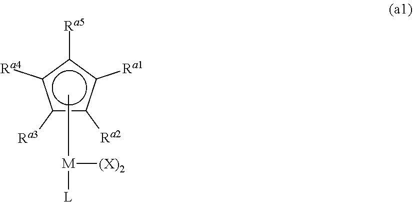

In the formula (a1), L represents a group represented by the following formula (a1a).

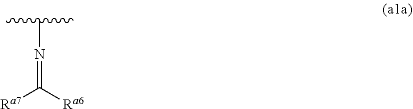

In the formula (a1), M represents Ti, Zr or Hf, and particularly preferably is Ti in light of ease of access to and production of the metallocene catalyst, as well as the activity of the catalyst, etc.

In the formula (a1), R^{a1} to R^{a5} may be identical to or different from one another, and each independently represent a hydrogen atom, an alkyl group optionally substituted with a halogen atom, or a trialkylsilyl group. At least one of R^{a1} to R^{a5} represents an alkyl group optionally substituted with a halogen atom, or a trialkylsilyl group. When only one of R^{a1} to R^{a5} represents the alkyl group optionally substituted with a halogen atom, or the trialkylsilyl group, the sum of the number of carbon atoms and the number of silicon atoms in the alkyl group optionally substituted with a halogen atom, or the trialkylsilyl group is 1 or more and 10 or less. When two or more of R^{a1} to R^{a5} represent the alkyl group optionally substituted with a halogen atom, or the trialkylsilyl group, the sum of the number of carbon atoms and the number of silicon atoms for all of R^{a1} to R^{a5} is 2 or more and 5 or less, and when R^{a1} to R³⁵ include an alkyl group having 2 to 4 carbon atoms and optionally substituted with a halogen atom, or the trimethylsilyl group, only one of R^{a1} to R^{a5} represents the alkyl group having 2 to 4 carbon atoms and optionally substituted with a halogen atom, or the trimethylsilyl group. Two adjacent groups from among R^{a1} to R^{a5} on the 5-membered ring are optionally bonded to each other to form a hydrocarbon ring.

It should be noted that the sum of the number of carbon atoms and the number of silicon atoms for all of R^{a1} to R^{a5} refers to the sum of the number of carbon atoms and the number of silicon atoms for R^{a1}, the number of carbon atoms and the number of silicon atoms for R^{a2}, the number of carbon atoms and the number of silicon atoms for R^{a3}, the number of carbon atoms and the number of silicon atoms for R^{a4}, and the number of carbon atoms and the number of silicon atoms for R^{a5}.

The number of carbon atoms of the alkyl group optionally substituted with a halogen atom as R^{a1} to R^{a5} is 1 or more and 10 or less, and preferably 1 or more and 4 or less. The alkyl group optionally substituted with a halogen atom as R^{a1} to R^{a5} may be linear or branched. The alkyl group as R^{a1} to R^{a5} is optionally substituted with a halogen atom. Examples of the halogen atom include a fluorine atom, a chlorine atom, a bromine atom, and an iodine atom, etc. The halogen atom is preferably a fluorine atom. When R^{a1} to R^{a5} each independently represent an unsubstituted alkyl group, preferable specific examples of the unsubstituted alkyl group include a methyl group, an ethyl group, an n-propyl group, an isopropyl group, an n-butyl group, an isobutyl group, a sec-butyl group, a tert-butyl group, an n-pentyl group, an n-hexyl group, an n-heptyl group, an n-octyl group, an n-nonyl group, and an n-decyl group. Suitable specific examples of the alkyl group substituted with a halogen atom as R^{a1} to R^{a5} include a fluoromethyl group, a trifluoromethyl group, a trichloromethyl group, a pentafluoroethyl group, and a 2,2,2-trifluoroethyl group.

The sum of the number of carbon atoms and the number of silicon atoms of the trialkylsilyl group as R^{a1} to R^{a5} is 4 or more and 10 or less, preferably 4 or more and 7 or less, and more preferably 4. Preferable specific examples of the trialkylsilyl group as R^{a1} to R^{a5} include a trimethylsilyl group, a dimethyl(ethyl)silyl group, and a triethylsilyl group. The trialkylsilyl group as R^{a1} to R^{a5} is preferably a trimethylsilyl group and a triethylsilyl group, and particularly preferably a trimethylsilyl group.

It is preferable in light of the tendency toward efficient production of the cyclic olefin copolymer that four of R^{a1} to R^{a6} represent a hydrogen atom or a methyl group, and one of R^{a1} to R^{a5} represents a trialkylsilyl group.

Preferable combinations of R^{a1} to R^{a5} are shown in Table 1 below. Values of the sum of the number of carbon atoms and the number of silicon atoms for all of R^{a1} to R^{a5} are also shown in Table 1. Abbreviations in Table 1 denote as follows.
H: hydrogen atom
Me: methyl group
Et: ethyl group
ⁿPr: n-propyl group
ⁱPr: isopropyl group
ⁿBu: n-butyl group
ⁱBu: isobutyl group
^{s}Bu: sec-butyl group
^{t}Bu: tert-butyl group
ⁿPen: n-pentyl group
ⁿHex: n-hexyl group
ⁿHep: n-heptyl group
ⁿOct: n-octyl group
ⁿNon: n-nonyl group
ⁿDec: n-decyl group
TMS: trimethylsilyl group

TABLE 1

| | Sum of number | | | | | |
|---|---|---|---|---|---|---|
| | of carbon atoms | | | | | |
| | and number of | | | | | |
| | silicon atoms | R^{a1} | R^{a2} | R^{a3} | R^{a4} | R^{a5} |
| Ligand 1 | 1 | Me | H | H | H | H |
| Ligand 2 | 2 | Et | H | H | H | H |
| Ligand 3 | 3 | ⁿPr | H | H | H | H |
| Ligand 4 | 3 | ⁱPr | H | H | H | H |
| Ligand 5 | 4 | ⁿBu | H | H | H | H |
| Ligand 6 | 4 | ⁱBu | H | H | H | H |
| Ligand 7 | 4 | ^{s}Bu | H | H | H | H |
| Ligand 8 | 4 | ^{t}Bu | H | H | H | H |
| Ligand 9 | 5 | ⁿPen | H | H | H | H |
| Ligand 10 | 6 | ⁿHex | H | H | H | H |
| Ligand 11 | 7 | ⁿHep | H | H | H | H |
| Ligand 12 | 8 | ⁿOct | H | H | H | H |
| Ligand 13 | 9 | ⁿNon | H | H | H | H |
| Ligand 14 | 10 | ⁿDec | H | H | H | H |
| Ligand 15 | 4 | TMS | H | H | H | H |
| Ligand 16 | 2 | Me | H | Me | H | H |
| Ligand 17 | 3 | Me | H | Et | H | H |
| Ligand 18 | 4 | Me | H | ⁿPr | H | H |
| Ligand 19 | 4 | Me | H | ⁱPr | H | H |
| Ligand 20 | 5 | Me | H | ⁿBu | H | H |
| Ligand 21 | 5 | Me | H | ⁱBu | H | H |
| Ligand 22 | 5 | Me | H | ^{s}Bu | H | H |
| Ligand 23 | 5 | Me | H | ^{t}Bu | H | H |
| Ligand 24 | 5 | Me | H | TMS | H | H |
| Ligand 25 | 3 | Me | Me | H | H | Me |
| Ligand 26 | 3 | Me | H | Me | H | Me |
| Ligand 27 | 5 | Me | Me | Me | Me | Me |

| | | |
|---|---|---|
| Ligand 28 | 4 | Indenyl ligand having ring formed |
| | | via bonding of R^{a1} and R^{a2} |

As described above, at least one of R^{a1} to R^{a5} represents an alkyl group optionally substituted with a halogen atom, or a trialkylsilyl group. Among these groups, unsubstituted alkyl groups and trialkylsilyl groups, which are an electron donating group, are preferable. When a ligand derived from a substituted cyclopentadiene has, as a substituent, an unsubstituted alkyl group and a trialkylsilyl group, which are electron donating groups, the strength of the coordination of the ligand derived from the substituted cyclopentadiene to the central metal M is enhanced in the metallocene compound represented by the formula (a1).

Further, when the ligand derived from the substituted cyclopentadiene has the alkyl group optionally substituted with a halogen atom or the trialkylsilyl group as a substituent such that the predetermined conditions with regard to the number of carbon atoms and the number of silicon atoms, as described above, are satisfied, a stable conformation is achieved by the rotation of the group represented by the formula (a1a), and a sufficiently large reaction field is ensured in the vicinity of the central metal M of the metallocene compound represented by the formula (a1).

Furthermore, in the ligand derived from the substituted cyclopentadiene, the structure and number of the substituent(s) bonded to the cyclopentadiene ring are restricted such that the conditions with regard to the number of carbon atoms and the number of silicon atoms in R^{a1} to R^{a5}, as described above, are satisfied. Also by this restriction, the stable conformation is achieved by the rotation of the group represented by the formula (a1a), and the sufficiently large reaction field is ensured in the vicinity of the central metal M of the metallocene compound represented by the formula (a1).

For the reasons described above, it is considered that the cyclic olefin copolymer is efficiently produced when R^{a1} to R^{a5} satisfy the predetermined conditions described above, since the polymerization can be performed using the sufficiently large reaction field on the metallocene catalyst while the stability of a catalyst active species is improved. In addition, in the sufficiently large reaction field, the norbornene monomer, which is larger in molecule size than ethylene, can also favorably participate in the reaction. This is thought to lead to higher incorporation of the structural unit derived from the norbornene monomer into the cyclic olefin copolymer, and suppression of the formation of the polyethylene-like impurity.

In the formula (a1), X represents an organic substituent having 1 to 20 carbon atoms and optionally containing a heteroatom, or a halogen atom. With regard to the organic substituent having 1 to 20 carbon atoms and optionally containing a heteroatom, when the organic substituent contains a heteroatom, the type of the heteroatom is not particularly limited, so long as the effects of the present invention are not impaired. Specific examples of the heteroatom include an oxygen atom, a nitrogen atom, a sulfur atom, a phosphorus atom, a silicon atom, a selenium atom, a halogen atom, etc.

The organic substituent is not particularly limited, so long as it does not inhibit the formation reaction of the metallocene compound represented by the formula (a1). Examples of the organic substituent include an alkyl group having 1 to 20 carbon atoms, an alkoxy group having 1 to 20 carbon atoms, a cycloalkyl group having 3 to 20 carbon atoms, an aliphatic acyl group having 2 to 20 carbon atoms, a benzoyl group, an α-naphthylcarbonyl group, a β-naphthylcarbonyl group, an aromatic hydrocarbon group having 6 to 20 carbon atoms, an aralkyl group having 7 to 20 carbon atoms, a trialkylsilyl group having 3 to 20 carbon atoms, a monosubstituted amino group substituted with a hydrocarbon group having 1 to 20 carbon atoms, and a disubstituted amino group substituted with a hydrocarbon group having 1 to 20 carbon atoms.

Among these organic substituents, an alkyl group having 1 to 6 carbon atoms, alkoxy group having 1 to 6 carbon atoms, a cycloalkyl group having 3 to 8 carbon atoms, an aliphatic acyl group having 2 to 6 carbon atoms, a benzoyl group, a phenyl group, a benzyl group, a phenethyl group and a trialkylsilyl group having 3 to 10 carbon atoms are preferable.

Among the organic substituents, a methyl group, an ethyl group, an n-propyl group, an isopropyl group, an n-butyl group, an isobutyl group, a sec-butyl group, a tert-butyl group, a methoxy group, an ethoxy group, an n-propyloxy group, an isopropyloxy group, an n-butyloxy group, an isobutyloxy group, a sec-butyloxy group, a tert-butyloxy group, an acetyl group, a propionyl group, a butanoyl group, a phenyl group, a trimethylsilyl group and a tert-butyldimethylsilyl group are more preferable.

X represents preferably a halogen atom, more preferably a chlorine atom or a bromine atom, and particularly preferably a chlorine atom.

In the formula (ala), R^{a6} and R^{a7} may be identical to or different from each other, and each independently represent a hydrogen atom, an organic substituent having 1 to 20 carbon atoms and optionally containing a heteroatom, or an inorganic substituent. Two groups R^{a6} and R^{a7} are optionally bonded to each other to form a ring. Specific examples and preferable examples of the organic substituent having 1 to 20 carbon atoms and optionally containing a heteroatom, as R^{a6} and R^{a7}, are the same as the specific examples and preferable examples of the organic substituent having 1 to 20 carbon atoms and optionally containing a heteroatom, as R^{a1} to R^{a5}. A monosubstituted amino group substituted with a hydrocarbon group having 1 to 20 carbon atoms, and a disubstituted amino group substituted with a hydrocarbon group having 1 to 20 carbon atoms are also preferable as the organic substituent. For the monosubstituted amino group or the disubstituted amino group as R^{a6} and R^{a7} in the formula (ala), preferable examples of the hydrocarbon group having 1 to 20 carbon atoms, which is bonded to the nitrogen atom, include the hydrocarbon groups included in the preferable examples of the organic substituent for R^{a1} to R^{a5}. The inorganic substituent as R^{a1} and R^{a7} in the formula (ala) is not particularly limited so long as it does not inhibit the formation reaction of the metallocene compound represented by the formula (a1). Specific examples of the inorganic substituent include a halogen atom, a nitro group, an unsubstituted amino group, and a cyano group, etc.

Preferable examples of the group represented by the formula (ala) include groups represented by L1 to L5 below, and the group represented by L1 is more preferable.

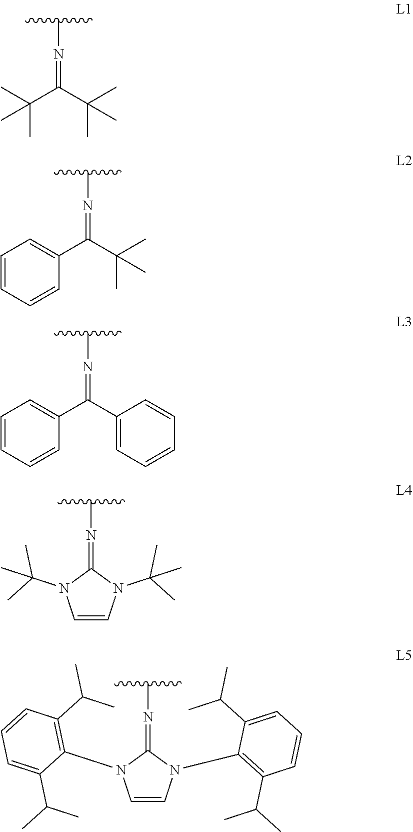

Preferable specific examples of the metallocene compound represented by the formula (a1) as described above include a metallocene compound in which the ligand derived from the substituted cyclopentadiene in the formula (a1) is any of ligands 1 to 28 shown in Table 1 described above, and both of two X in the formula (a1) represent a halogen atom, and the group represented by the formula (a1a) is the group represented by L1. As described above, Ti is preferable as the central metal M.

In light of high catalyst activity, and the ability to efficiently produce the cyclic olefin copolymer even in the case of a polymerization reaction over a long period of time, a metallocene compound in which the ligand derived from the substituted cyclopentadiene in the formula (a1) is any of ligands 1, 5 to 8, 15, and 24 shown in Table 1, both of two X in the formula (a1) represent a halogen atom, the group represented by the formula (a1a) is the group represented by L1, and the central metal M represents Ti, is preferable. The ligand derived from the substituted cyclopentadiene in the formula (a1) is more preferably any of ligands 5, 8, 15, and 24 shown in Table 1, and even more preferably ligand 15 or 24.

In addition, a metallocene compound in which the ligand derived from the substituted cyclopentadiene in the formula (a1) is any of ligands 20 to 23 shown in Table 1, both of two X in the formula (a1) represent a halogen atom, the group represented by the formula (a1a) is the group represented by L1, and the central metal M represents Ti, is preferable in light of ease of production of the metallocene compound. The ligand derived from the substituted cyclopentadiene in the formula (a1) is more preferably ligand 20 or 23 shown in Table 1.

The monomers in the polymerization vessel are polymerized in the presence of the metallocene catalyst described above.

The polymerization of the monomers is preferably performed in the presence of the metallocene catalyst as described above and a co-catalyst. A compound which is generally used as a co-catalyst in the polymerization of olefins can be used as the co-catalyst without particular limitation. Suitable examples of the co-catalyst include an aluminoxane and an ionic compound. The polymerization of the monomers is performed, in particular, using preferably at least one selected from the aluminoxane or a borate compound as the ionic compound as the co-catalyst, in light of favorable progress of the polymerization reaction.

In other words, the polymerization of the monomers is performed preferably in the presence of the metallocene catalyst, and at least one selected from the aluminoxane or the borate compound.

The metallocene catalyst described above is preferably mixed with the aluminoxane and/or the ionic compound to give a catalyst composition. In this regard, the ionic compound is a compound that forms a cationic transition metal compound through the reaction with the metallocene catalyst.

The catalyst composition is preferably prepared using a solution of the metallocene catalyst. A solvent contained in the solution of the metallocene catalyst is not particularly limited. Examples of a preferable solvent include aliphatic hydrocarbon solvents such as pentane, hexane, heptane, octane, isooctane, isododecane, mineral oils, cyclohexane, methylcyclohexane, decahydronaphthalene (decalin), and mineral oils; aromatic hydrocarbon solvents such as benzene, toluene, and xylene; and halogenated hydrocarbon solvents such as chloroform, methylene chloride, dichloromethane, dichloroethane, and chlorobenzene.

The amount of the solvent used is not particularly limited so long as a catalyst composition having the desired performance can be produced. Typically, an amount of solvent is used such that the concentration of the metallocene catalyst, the aluminoxane and the ionic compound is preferably 0.00000001 to 100 mol/L, more preferably 0.00000005 to 50 mol/L, and particularly preferably 0.0000001 to 20 mol/L.

In mixing liquids containing basic ingredients of the catalyst composition, the liquids are preferably mixed such that a value of (M_{b1}+M_{b2})/Mₐ, wherein Mₐ represents the number of moles of the transition metal element in the metallocene catalyst, M_{b1} represents the number of moles of aluminum in the aluminoxane, and M_{b2} represents the number of moles of the ionic compound, is preferably 1 to 200,000, more preferably 5 to 100,000, and particularly preferably 10 to 80,000.

The temperature at which the liquids containing the basic ingredients of the catalyst composition are mixed is not particularly limited, and is preferably −100 to 100° C., and more preferably −50 to 50° C.

The mixing of a solution of the metallocene catalyst with the aluminoxane and/or the ionic compound for the preparation of the catalyst composition may be performed prior to the polymerization in an apparatus separate from the polymerization vessel, or may be performed prior to or during the polymerization in the polymerization vessel.

In the following, materials used in the preparation of the catalyst composition, and conditions for the preparation of the catalyst composition will be described.

### [Aluminoxane]

Various aluminoxanes which have conventionally been used as a co-catalyst, etc. in the polymerization of various olefin can be used as the aluminoxane of the present invention without particular limitation. Typically, the aluminoxane is an organic aluminoxane. In the production of the catalyst composition, one type of the aluminoxane may be used alone, and two or more types of aluminoxanes may be used in combination.

An alkylaluminoxane is preferably used as the aluminoxane. Examples of the alkylaluminoxane include a compound represented by the following formula (b1-1) or (b1-2). The alkylaluminoxane represented by the following formula (b1-1) or (b1-2) is a product of the reaction of trialkylaluminum with water.

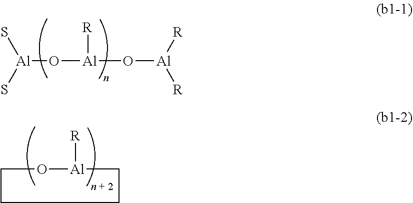

In the formulas (b1-1) and (b1-2), R represents an alkyl group having 1 to 4 carbon atoms, and n represents an integer of 0 to 40, preferably 2 to 30.

The alkylaluminoxane includes methylaluminoxane, and a modified methylaluminoxane in which a part of methyl groups in the methylaluminoxane are replaced with another alkyl group. The modified methylaluminoxane is preferably, for example, a modified methylaluminoxane having, as a replacing alkyl group, an alkyl group having 2 to 4 carbon atoms, such as an ethyl group, a propyl group, an isopropyl group, a butyl group and an isobutyl group, and, in particular, more preferably a modified methylaluminoxane in which a part of methyl groups in the methylaluminoxane are replaced with an isobutyl group. Specific examples of the alkylaluminoxane include methylaluminoxane, ethylaluminoxane, propylaluminoxane, butylaluminoxane, isobutylaluminoxane, methylethylaluminoxane, methylbutylaluminoxane, methylisobutylaluminoxane, etc., and among these, methylaluminoxane and methylisobutylaluminoxane are preferable.

The alkylaluminoxane can be prepared by any known method. Alternatively, commercially available products of the alkylaluminoxane may be used. Examples of the commercially available products of the alkylaluminoxane include MMAO-3A, TMAO-200 series, TMAO-340 series, solid MAO (each manufactured by Tosoh Finechem Corporation) and a methylaluminoxane solution (manufactured by Albemarle Corporation), etc. More preferably, an alkylaluminoxane other than solid MAO is used in light of the tendency toward reliable suppression of the formation of the polyethylene-like impurity.

### [Ionic Compound]

The ionic compound forms a cationic transition metal compound upon the reaction with the metal-containing catalyst. An ionic compound having an ion such as a tetrakis(pentafluorophenyl)borate anion, an amine cation having an active proton such as dimethylphenylammonium cation ((CH₃)₂N(C₅H₅)H⁺), a trisubstituted carbonium cation such as (C₆H₅)₃C⁺, a carborane cation, a metal carborane cation and a ferrocenium cation having a transition metal may be used as the ionic compound.

Suitable examples of the ionic compound include a borate. Specific examples of a preferable borate include trityl tetrakis(pentafluorophenyl)borate, dimethylphenylammonium tetrakis(pentafluorophenyl)borate and an N-methyldialkylammonium tetrakis(pentafluorophenyl)borate such as N,N-dimethylanilinium tetrakis(pentafluorophenyl)borate and N-methyldi-n-decylammonium tetrakis(pentafluorophenyl)borate.

Further, one or more selected from an aluminoxane, an aromatic compound having one or more phenolic hydroxyl groups and one or more halogen atoms on its aromatic ring, or a hindered phenol are preferably contained in the polymerization vessel prior to the addition of the metallocene catalyst, or the catalyst composition containing the metallocene catalyst, in light of the tendency toward the production of the cyclic olefin copolymer in favorable yields. The aromatic compound having one or more phenolic hydroxyl groups and one or more halogen atoms has at least one aromatic ring having at least one of the one or more phenolic hydroxyl groups and at least one of the one or more halogen atoms bonded thereto, and the aromatic ring(s) may be a monocyclic ring or a fused ring. The hindered phenol is a phenol having a bulky substituent in at least one of two positions adjacent to the position of a phenolic hydroxyl group. Examples of the bulky substituent include an alkyl group other than a methyl group, such as an isopropyl group, an isobutyl group, a sec-butyl group and a tert-butyl group, an alkenyl group, an alkynyl group, an aryl group, a heterocyclic group, an alkoxy group, an aryloxy group, a substituted amino group, an alkylthio group, an arylthio group, etc.

Specific examples of the hindered phenol include 2,6-di-tert-butyl-p-cresol (BHT), 2,6-di-tert-butylphenol, 2-tert-butylphenol, 2-tert-butyl-p-cresol, 3,3′,5,5′-tetra-tert-butyl-4,4′-dihydroxybiphenyl, 3,3′,5,5′-tetra-tert-butyl-2,2′-dihydroxybiphenyl, 4,4′-butylidenebis(3-methyl-6-tert-butylphenol), 2,2′-methylenebis(6-tert-butyl-4-methylphenol), 4,4′,4″-(1-methylpropanyl-3-ylidene)tris(6-tert-butyl-m-cresol), and 1,3,5-tris(3,5-di-tert-butyl-4-hydroxyphenylmethyl)-2,4,6-trimethylbenzene, etc. Among these, 2,6-di-tert-butyl-p-cresol (BHT) and 2,6-di-tert-butylphenol are preferable in light of their low molecular weight and their tendency toward the achievement of the desired effects in the use of a small amount of the hindered phenol. The hindered phenol reacts with the alkylaluminum compound in the polymerization system and contributes to an increase in yield of the cyclic olefin copolymer. Thus, the hindered phenol is preferably used with the alkylaluminum. The hindered phenol may be mixed with the alkylaluminum in a polymerization reactor and used. A mixture obtained by mixing the alkylaluminum and the hindered phenol prior to the polymerization may be introduced into a polymerization reactor.

The aluminoxane is as described in relation to the production method of the catalyst composition.

In the case where the aluminoxane is added to the polymerization vessel prior to the addition of the metallocene catalyst, or the catalyst composition containing the metallocene catalyst, the amount of the aluminoxane used is preferably 1 to 1,000,000 moles, and more preferably 10 to 100,000 moles in terms of the number of moles of aluminum in the aluminoxane per mole of the metallocene catalyst.

It is also preferable that the polymerization is performed in the presence of the metallocene catalyst and the aluminoxane, or in the presence of the metallocene catalyst, the ionic compound and the hindered phenol.

In addition, it is also preferable that the polymerization of the monomers is performed in the presence of the metallocene catalyst as described above and an alkylmetal compound. The alkylmetal compound may be added to the catalyst composition, or fed to the polymerization vessel separately from the catalyst composition.

It is preferable to employ, as the alkylmetal compound, at least one of an alkylaluminum compound having at least one alkyl group bonded to an Al atom, or an alkylzinc compound having at least one alkyl group bonded to a Zn atom. The use of a combination of the metallocene catalyst described above and the alkylmetal compound allows for efficient production of a cyclic olefin copolymer by copolymerizing monomers including a norbornene monomer and ethylene while suppressing the formation of a polyethylene-like impurity and an excessive increase in molecular weight.

One type of the alkylmetal compound may be used alone, or two or more types of alkylmetal compounds may be used in combination.

An alkylaluminum compound which has been conventionally used in the polymerization of olefins or the like can be used as the alkylaluminum compound of the present invention without particular limitation. Examples of the alkylaluminum compound include compounds represented by the following general formula (II).

(R⁰¹)_{z1}AlX_{3-z1} (II)

In the formula (II), R⁰¹ represents an alkyl group having 1 to 15 carbon atoms, X represents a halogen atom or a hydrogen atom, and z1 represents an integer of 1 to 3.

The number of carbon atoms of the alkyl group as R⁰¹ is 1 to 15, in view of ease of obtaining the desired effect, more preferably 1 to 8, and even more preferably 2 to 8. Preferable specific examples of the alkyl group include a methyl group, an ethyl group, an n-propyl group, an isopropyl group, an n-butyl group, an isobutyl group, an n-pentyl group, an n-hexyl group, an n-heptyl group, an n-octyl group, etc.

The specific examples of the alkylaluminum compound include trialkylaluminums such as trimethylaluminum, triethylaluminum, tri-n-propylaluminum, triisopropylaluminum, tri-n-butylaluminum, triisobutylaluminum, tri-sec-butylaluminum, tri-n-pentylaluminum, tri-n-hexylaluminum, tri-n-heptylaluminum, and tri-n-octylaluminum; dialkylaluminum halides such as dimethylaluminum chloride, diethylaluminum chloride, and diisobutylaluminum chloride; dialkylaluminum hydrides such as dimethylaluminum hydride, diethylaluminum hydride, di-n-propyldimethylaluminum hydride, diisopropyldimethylaluminum hydride, di-n-butylaluminum hydride, diisobutylaluminum hydride, di-sec-butylaluminum hydride, di-n-pentylaluminum hydride, di-n-hexylaluminum hydride, di-n-heptylaluminum hydride, and di-n-octylaluminum hydride; and dialkylaluminum alkoxides such as dimethylaluminum methoxide.

An alkylzinc compound which has been conventionally used in the polymerization of olefins or the like can be used as the alkylzinc compound of the present invention without particular limitation. Examples of the alkylzinc compound include compounds represented by the following general formula (III).

(R⁰²)_{z2}ZnX_{2-z2} (III)

In the formula (III), R⁰² represents an alkyl group having 1 to 15 carbon atoms, and preferably 1 to 8 carbon atoms, X represents a halogen atom or a hydrogen atom, and z2 represents an integer of 1 to 3.

The number of carbon atoms of the alkyl group as R⁰² is 1 to 15, in view of ease of obtaining the desired effects, more preferably 1 to 8, and even more preferably 2 to 8. Preferable specific examples of the alkyl group include a methyl group, an ethyl group, an n-propyl group, an isopropyl group, an n-butyl group, an isobutyl group, an n-pentyl group, an n-hexyl group, an n-heptyl group, an n-octyl group, etc.

Specific examples of the alkylzinc compound include dialkylzincs such as dimethylzinc, diethylzinc, di-n-propylzinc, diisopropylzinc, di-n-butylzinc, diisobutylzinc, di-sec-butylzinc, di-n-pentylzinc, di-n-hexylzinc, di-n-heptylzinc, and di-n-octylzinc; alkylzinc halides such as methylzinc chloride, ethylzinc chloride, and isobutylzinc chloride; and alkylzinc hydrides such as methylzinc hydride, ethylzinc hydride, and isobutylzinc hydride.

Among the alkylmetal compounds, one or more selected from the group consisting of a trialkylaluminum, a dialkylaluminum hydride and a dialkylzinc are preferable, and a trialkylaluminum and/or a dialkylaluminum hydride are more preferable.

The amount of the alkylmetal compound used together with the metallocene catalyst is preferably 1 to 500,000 moles, and more preferably 10 to 50,000 moles in terms of the sum of the moles of aluminum and the moles of zinc per mole of the metallocene catalyst.

The polymerization conditions are not limited, so long as a cyclic olefin copolymer having the desired physical properties, and any known conditions may be employed. The amount of the catalyst composition used is derived from the amount of the metallocene compound used in the preparation of the catalyst composition. The amount of the catalyst composition used per mole of the norbornene monomer is preferably 0.000000001 to 0.005 moles, and more preferably 0.00000001 to 0.0005 moles in terms of the amount of the metallocene compound used in the preparation of the catalyst composition.

The polymerization time is not particularly limited, and the polymerization is performed until the desired yield is reached or the molecular weight of the polymer is increased to the desired degree. The polymerization time also varies depending on the temperature, the catalyst composition and the monomer composition, and is typically 0.01 h to 120 h, preferably 0.1 h to 80 h, and more preferably 0.2 h to 10 h.

It is preferable that at least a part, and preferably the entirety, of the catalyst composition is continuously added to the polymerization vessel. The continuous addition of the catalyst composition allows for continuous production of the cyclic olefin copolymer, and leads to the reduction of production costs of the cyclic olefin copolymer.

The method described above can efficiently produce the cyclic olefin copolymer by copolymerizing the monomers including the norbornene monomer and ethylene while suppressing the formation of a polyethylene-like impurity. The glass transition temperature of the resulting cyclic olefin copolymer is not particularly limited, and is, for example, preferably 185° C. or lower, more preferably 160° C. or lower, even more preferably 130° C. or lower, still more preferably 120° C. or lower, and particularly preferably 100° C. or lower, in view of processability. Further, when a sample of the cyclic olefin copolymer produced according to the method described above is subjected to the measurement according to the method defined in JIS K7121 using a differential scanning calorimeter (DSC) in a nitrogen atmosphere under the condition of a rate of temperature increase of 20° C./min, the obtained DSC curve preferably shows no peak of the melting point (enthalpy of fusion) assigned to the polyethylene-like impurity. This means no or very little polyethylene-like impurity in the cyclic olefin copolymer. It should be noted that in the presence of the polyethylene-like impurity in the cyclic olefin copolymer, a peak of the melting point assigned to the polyethylene-like impurity on the DSC curve will be generally detected in the range of 100° C. to 140° C.

The cyclic olefin copolymer produced according to the method described above contains a trace amount of the polyethylene-like impurity and is excellent in transparency.

Therefore, the cyclic olefin copolymer produced according to the method described above is particularly preferably used for, e.g., materials of optical films or sheets, and films or sheets for packaging materials, which are required to have a high degree of transparency from the viewpoints of optical function and aesthetics.

### EXAMPLES

In the following, the present invention is specifically described with reference to Examples, but the present invention is not limited to these Examples.

### Examples 1 to 18, and Comparative Examples 1 to 5

In Examples 1 to 18, a compound represented by the formula (a1) described above, in which M represents Ti, X represents a chlorine atom, and R^{a6} and R^{a7} each independently represent a tert-butyl group, and in which the compound had a ligand of the number specified in Table 3, was used as a metallocene catalyst in the production of a cyclic olefin resin composition. It should be noted that the ligand numbers specified in Table 3 correspond to the ligand numbers specified in Table 1. In Comparative Examples 1 to 5, a compound represented by the formula (a1) described above, in which M represents Ti, X represents a chlorine atom, and R^{a3} and R^{a7} each independently represent a tert-butyl group, and in which the compound had a ligand of the number specified in Table 2, was used as a metallocene catalyst. It should be noted that the ligand numbers specified in Table 3 correspond to the ligand numbers specified in Table 2.

TABLE 2

| | Sum of number | | | | | |
|---|---|---|---|---|---|---|
| | of carbon atoms | | | | | |
| | and number of | | | | | |
| | silicon atoms | R^{a1} | R^{a2} | R^{a3} | R^{a4} | R^{a5} |
| Ligand 0 | 0 | H | H | H | H | H |
| Ligand 29 | 6 | ^{t}Bu | H | Et | H | H |
| Ligand 30 | 7 | ^{t}Bu | H | ⁿPr | H | H |
| Ligand 31 | 8 | ^{t}Bu | H | ^{t}Bu | H | H |

In Examples 1 to 18 and Comparative Examples 1 to 5, the following CC1 to CC7 were used as a co-catalyst.
CC1: a 6.5% by mass (in terms of the content of the Al atom) MMAO-3A solution in toluene (a solution of methylisobutylaluminoxane represented by [(CH₃)_{0.7}(iso-C₄H₉)_{0.3}AlO]ₙ; from Tosoh Finechem Corporation; this solution contained 6 mols of trimethylaluminum based on the total Al)
CC2: a 40.6% by mass (in terms of the content of the Al atom) solid MAO solution in toluene (mean particle diameter: d(0.5) 5.6 μm (dispersion medium for measurement: toluene), slurry concentration: 12.2 wt %; from Tosoh Finechem Corporation)
CC3: N-methyldialkylammonium tetrakis(pentafluorophenyl)borate (alkyl: C14 to C18 (average: C17.5)) (from Tosoh Finechem Corporation)
CC4: triisobutylaluminum (from Tosoh Finechem Corporation)
CC5: trioctylaluminum (from Tosoh Finechem Corporation)
CC6: diisopropylzinc (from Aldrich)
CC7: diethylaluminum chloride (from Tosoh Finechem Corporation)

A solvent specified in Table 3 as a solvent for polymerization and 2-norbornene in an amount specified in Table 3 (Nb amount: 19 to 90 mmol) were added to a 150 mL, adequately-dried stainless-steel autoclave containing a stirring bar. A co-catalyst specified in Table 3 was then added. It should be noted that CC3 was added after the addition of a metallocene catalyst solution. The metallocene catalyst solution was prepared using the solvent specified in Table 3. After the addition of the co-catalyst as described above, the autoclave was heated to 90° C., and then the metallocene catalyst solution was added such that the amount of the metallocene catalyst was as specified in Table 3. Next, an ethylene pressure (gauge pressure) of 0.9 MPa was applied, and the polymerization reaction was initiated, considering the time when 30 seconds had elapsed after the application of the ethylene pressure to be the polymerization starting point. However, in Examples 9, 11, and 13, in which CC3 was used, the metallocene catalyst solution was added such that the amount of the metallocene catalyst was as specified in Table 3, a solution of CC3 prepared using the solvent specified in Table 3 was added, and then an ethylene pressure (gauge pressure) of 0.9 MPa was applied. Incidentally, the total volume of the monomer solution immediately before the application of the ethylene pressure was 80 mL. Fifteen minutes after the start of the polymerization, the ethylene feed was stopped, the pressure was carefully reduced to the atmospheric pressure, and then isopropyl alcohol was added to the reaction solution to quench the reaction. Subsequently, the polymerization solution was poured into a solvent mixture of 300 mL of acetone, 200 mL of methanol or isopropyl alcohol, and 5 mL of hydrochloric acid to precipitate the copolymer. The copolymer was collected via suction filtration, followed by washing with acetone and methanol, and then the copolymer was dried in vacuo at 110° C. for 12 h, to give a copolymer of norbornene and ethylene. The copolymer yield (kg) per gram of the catalyst, which is calculated from the amount of the catalyst used and the amount of the copolymer thus obtained, is listed in Table 3.

In addition, the measurement of the glass transition temperature and the molecular weight, the thermal analysis for an impurity and a turbidity test, for confirming the presence or absence of the polyethylene-like impurity were performed according to the following methods. The measurement results of the glass transition temperature and the molecular weight and the results of the thermal analysis for the impurity are shown in Table 3.

### <Glass Transition Temperature (Tg)>

The Tg of the cyclic olefin copolymer was measured according to the DSC method (method defined in JIS K7121). DSC apparatus: differential scanning calorimeter (DSC-Q1000, from TA Instrument)
measurement atmosphere: nitrogen
condition for temperature increase: 20° C./min

### <Molecular Weight Measurement>

The number-average molecular weight (Mn) and the weight-average molecular weight (Mw) were measured by gel permeation chromatography under the following measurement conditions.
apparatus: Viscotek TDA302 Detector and Pump Autosampler
apparatus from Malvern
detector: RI
solvent: toluene
column: TSKgel GMHHR-M (300 mm×7.8 mm(p) from Tosoh
Corporation
flow rate: 1 mL/min
temperature: 75° C.
sample concentration: 2.5 mg/mL
injection volume: 100 μL
standard samples: monodisperse polystyrenes

### <Thermal Analysis for Impurity>

The amount of exotherm (mJ/mg) was calculated based on an area of a peak assigned to the melting point of the polyethylene-like impurity, which was observed in the range of 100° C. to 140° C. on the DSC curve obtained in the measurement of the glass transition temperature. A larger calculated amount of exotherm indicates a higher content of the polyethylene-like impurity. It should be noted that “ND” in Table 3 indicates that no peak assigned to the melting point of the polyethylene-like impurity was detected on the DSC curve.

### <Turbidity Test>

After the dissolution of 0.1 g of the obtained cyclic olefin copolymer in 10 g of toluene, the presence or absence of the turbidity in the solution was observed. When turbidity is found, the polyethylene-like impurity is contained in the cyclic olefin copolymer. When no turbidity is found, no polyethylene-like impurity is contained in the cyclic olefin copolymer. As a result of the turbidity test, the turbidity was found in Comparative Examples 1 and 2, while the turbidity was not found in other Examples and Comparative Examples. The result that the turbidity was found in Comparative Examples 1 and 2 is consistent with the results of the thermal analysis for the impurity.

TABLE 3

| | | | Co-catalys | | | | Copolymer | | | Thermal |
|---|---|---|---|---|---|---|---|---|---|---|
| | Metallocene | | | Amount | | | yield per | | | analysis |
| | catalyst | | | mol/ | | Nb | gram of | | | for |
| | | Amount | | catalyst | | amount | catalyst | | Tg | impurity |
| | Ligand | mmol | Type | 1 mol | Solvent | mmol | g/g | Mn ×10⁻³ | ° C. | mJ/mg |
| Ex. 1 | 1 | 0.5 | CC1 | 5000 | Toluene | 60 | 18372 | 51 | 97 | ND |
| Ex. 2 | 1 | 0.5 | CC1 | 5000 | Decalin | 75 | 7955 | 39 | 94 | ND |
| Ex. 3 | 1 | 0.5 | CC2 | 5000 | Decalin | 75 | 15152 | 447 | 99 | ND |
| Ex. 4 | 1 | 0.5 | CC2/ | 5000/ | Decalin | 75 | 16970 | 159 | 91 | ND |
| | | | CC5 | 150 | | | | | | |
| Ex. 5 | 1 | 0.5 | CC2/ | 5000/ | Decalin | 75 | 3030 | 65 | 78 | ND |
| | | | CC6 | 150 | | | | | | |
| Ex. 6 | 1 | 0.5 | CC2/ | 5000/ | Decalin | 75 | 3637 | 312 | 101 | ND |
| | | | CC7 | 150 | | | | | | |
| Ex. 7 | 5 | 0.5 | CC1 | 5000 | Decalin | 75 | 8426 | 31 | 91 | ND |
| Ex. 8 | 8 | 0.5 | CC1 | 5000 | Decalin | 75 | 8196 | 64 | 87 | ND |
| Ex. 9 | 15 | 0.5 | CC1 | 5000 | Decalin | 75 | 13833 | 56 | 94 | ND |
| Ex. 10 | 15 | 0.2 | CC3/ | 1.5/ | Decalin | 75 | 16736 | 70 | 102 | ND |
| | | | CC4 | 2000 | | | | | | |
| Ex. 11 | 23 | 0.5 | CC1 | 5000 | Decalin | 90 | 6294 | 39 | 81 | ND |
| Ex. 12 | 23 | 0.2 | CC3/ | 1.5/ | Decalin | 90 | 11157 | 69 | 94 | ND |
| | | | CC4 | 2000 | | | | | | |
| Ex. 13 | 24 | 0.5 | CC1 | 5000 | Decalin | 90 | 10230 | 43 | 90 | ND |
| Ex. 14 | 24 | 0.2 | CC3/ | 1.5/ | Decalin | 90 | 20083 | 79 | 97 | ND |
| | | | CC4 | 2000 | | | | | | |
| Ex. 15 | 25 | 0.5 | CC1 | 5000 | Decalin | 43 | 7574 | 58 | 91 | ND |
| Ex. 16 | 26 | 0.5 | CC1 | 5000 | Decalin | 35 | 7613 | 74 | 85 | ND |
| Ex. 17 | 27 | 0.5 | CC1 | 5000 | Decalin | 19 | 3078 | 87 | 82 | ND |
| Ex. 18 | 28 | 0.5 | CC1 | 5000 | Decalin | 65 | 11340 | 113 | 88 | ND |
| Comp. Ex. 1 | 0 | 0.5 | CC1 | 5000 | Decalin | 45 | 4940 | 30 | 65 | 0.6 |
| Comp. Ex. 2 | 0 | 0.5 | CC2 | 5000 | Decalin | 45 | 8960 | 371 | 71 | 1.1 |
| Comp. Ex. 3 | 29 | 0.5 | CC1 | 5000 | Decalin | 75 | 2761 | 64 | 105 | ND |
| Comp. Ex. 4 | 30 | 0.5 | CC1 | 5000 | Decalin | 75 | 2033 | 53 | 98 | ND |
| Comp. Ex. 5 | 31 | 0.5 | CC1 | 5000 | Decalin | 75 | 1617 | 85 | 95 | ND |

According to Examples 1 to 18, it can be found that the use of the metallocene catalyst of the predetermined structure, which has the ligand satisfying the specific requirements, allows for efficient production of a cyclic olefin copolymer by copolymerizing the monomers including a norbornene monomer and ethylene while suppressing the formation of the polyethylene-like impurity. In addition, it can be seen from comparison between Example 3 and Examples 4 to 6 that the use of the metallocene catalyst of the predetermined structure and an alkylmetal compound such as an alkylaluminum compound or an alkylzinc compound in combination leads to reliable suppression of the increase in molecular weight of the resulting copolymer without unduly reducing the yield of the copolymer. According to Comparative Examples 1 and 2, it can be found that when the cyclopentadiene ligand in the metallocene catalyst described above is an unsubstituted cyclopentadiene ligand, a polyethylene-like impurity is likely to form. Further, according to Comparative Examples 3 to 5, it can be found that in the metallocene catalyst described above, when the sum of the number of carbon atoms and the number of silicon atoms for the substituent(s) on the cyclopentadiene ligand is excessively large, the cyclic olefin copolymer is less likely to be produced efficiently.

1. A method for producing a cyclic olefin copolymer comprising a structural unit derived from a norbornene monomer and a structural unit derived from ethylene, the method comprising:
charging at least the norbornene monomer and the ethylene as monomers into a polymerization vessel; and
polymerizing the monomers in the polymerization vessel in presence of a metallocene catalyst, wherein
the metallocene catalyst is a compound represented by formula (a1): 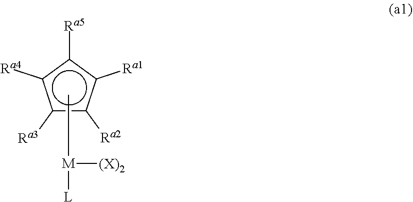
wherein in the formula (a1), M represents Ti, Zr, or Hf,
R^{a1} to R^{a5} are identical to or different from one another, and each independently represents a hydrogen atom, an alkyl group optionally substituted with a halogen atom, or a trialkylsilyl group,
wherein at least one of R^{a1} to R^{a5} represents the alkyl group optionally substituted with a halogen atom, or the trialkylsilyl group,
when only one of R^{a1} to R^{a5} represents the alkyl group optionally substituted with a halogen atom, or the trialkylsilyl group, a sum of the number of carbon atoms and the number of silicon atoms in the alkyl group optionally substituted with a halogen atom, or the trialkylsilyl group is 1 or more and 10 or less,
when two or more of R^{a1} to R^{a5} represent the alkyl group optionally substituted with a halogen atom, or the trialkylsilyl group, a sum of the number of carbon atoms and the number of silicon atoms for all of R^{a1} to R^{a5} is 2 or more and 5 or less, and when R^{a1} to R^{a5} comprise the alkyl group having 2 to 4 carbon atoms and optionally substituted with the halogen atom, or the trimethylsilyl group, only one of R^{a1} to RV represents the alkyl group having 2 to 4 carbon atoms and optionally substituted with the halogen atom, or the trimethylsilyl group, and
two adjacent groups from among R^{a1} to R^{a5} on a 5-membered ring are optionally bonded to each other to form a hydrocarbon ring,
X represents an organic substituent having 1 to 20 carbon atoms and optionally containing a heteroatom, or a halogen atom, and
L represents a group represented by formula (a1a): 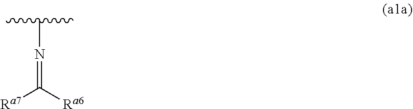
wherein in the formula (a1a), R^{a6} and R^{a7} are identical to or different from each other, and each independently represents a hydrogen atom, an organic substituent having 1 to 20 carbon atoms and optionally contains a heteroatom, or an inorganic substituent, and two groups R^{a6} and R^{a7} are optionally bonded to each other to form a ring.

2. The method for producing a cyclic olefin copolymer according to claim 1, wherein four of R^{a1} to R^{a5} represent the hydrogen atom or a methyl group, and one of R^{a1} to R^{a5} represents the trialkylsilyl group.

3. The method for producing a cyclic olefin copolymer according to claim 1, wherein the M represents Ti.

4. The method for producing a cyclic olefin copolymer according to claim 1, wherein the polymerizing of the monomers is performed in the presence of the metallocene catalyst, and at least one of an aluminoxane or a borate compound.

5. The method for producing a cyclic olefin copolymer according to claim 1, wherein the polymerizing of the monomers is performed in the presence of an aliphatic hydrocarbon solvent.

6. The method for producing a cyclic olefin copolymer according to claim 1, wherein a DSC curve obtained in measurement of a sample of the cyclic olefin copolymer according to a method defined in JIS K7121 using a differential scanning calorimeter in a nitrogen atmosphere under a condition of a rate of temperature increase of 20° C./min shows no peak of a melting point assigned to a polyethylene-like impurity in a range of 100° C. to 140° C.
